(19) United States
(12) Patent Application Publication
(10) Pub. No.: US 2005/0193631 A1
(43) Pub. Date: Sep. 8, 2005

(54) Balance shoe for tilt-in window sashes

(76) Inventors: Gary Marshik, Canton, SD (US); Stephen M. Piltingsrud, Sioux Falls, SD (US); James Ripley, Canton, SD (US); Lawrence J. VerSteeg, Sioux Falls, SD (US)

Correspondence Address: GOODWIN PROCTER LLP;PATENT ADMINISTRATOR, EXCHANGE PLACE, BOSTON, MA, 02109-2881, US

(21) Appl. No.: 10/795,966

(22) Filed: Mar. 8, 2004

(51) Int. Cl. E05D 15/22

(52) U.S. Cl. 49/183

(57) ABSTRACT

The invention relates to tilt-in window assemblies, in which a sash may be tilted into a room or removed from a window jamb. When the sash is tilted or removed, a balance shoe that is connected to a window balance engages the window jamb and prevents the sash and the window balance from releasing and travelling vertically in the window jamb. The balance shoe is biased into a locked position when a pivot bar coupled to the sash is disengaged from a camming surface of the balance shoe, as occurs when the sash is tilted or removed from the window jamb. Upon return of the sash to its normal vertical position in the window jamb, the pivot bar engages the camming surface and the balance shoe disengages the window jamb.

### TECHNICAL FIELD

The invention relates generally to tilt-in window sashes and, more specifically, to a balance shoe for engaging a rigid sash guide or window jamb when the sash is tilted out of or removed from the jamb.

### BACKGROUND OF THE INVENTION

The invention relates to a balance shoe of a window balance system used in conjunction with a pivot bar mounted on a window sash for rotating the window sash relative to a window frame.

Tilt-in window sashes typically appear in a double hung version, with a lower sash and an upper sash. The two sashes are disposed in tracks located in a window frame to allow vertical sliding movement of the sashes. Pivot bars are provided on the window sashes to allow rotational movement of the sashes relative to the window frame to facilitate cleaning and replacement of damaged glass panes. To control vertical movement of the sashes, window balances are provided to hold the windows in the positions in which they are placed, the window balances being disposed in window jambs that lie on each side of the window sashes. Balance shoes, which are coupled to the window balances and located in the window jambs, are used to guide the rotational movement of the window sashes with respect to the window frame.

One problem associated with tilt-in window sashes concerns the ability to control the end of the window balance that is coupled to the window sash via the balance shoe and the pivot bar. In situations where the sash is tilted into a room, or when the full weight of the sash is unavailable to offset the upward pull of the window balance, it is desirable to lock the end of the window balance in a fixed vertical position within the window jamb. Without a locking mechanism, the end of the sash connected to the balance could rise in the window jamb in an uncontrolled and/or abrupt manner, potentially causing injury to a user and/or damaging the sash and the window jamb.

Many types of locking mechanisms have been developed in an attempt to overcome the difficulty described. Examples of locking mechanisms can be found in U.S. Pat. Nos. 3,055,062; 3,195,174; 3,524,282; 3,676,956; 3,797,168; 3,842,540; 3,844,066; 4,079,549; 4,364,199; 4,610,108; and 5,873,199; all the disclosures of which are hereby incorporated by reference herein in their entireties. One difficulty associated with prior art locking mechanisms is that they may slip or creep vertically, even when they are in the locked position, causing the end of the sash to rise. It is, therefore, an object of the invention to provide a more positive locking mechanism coupled to the balance shoe that overcomes the difficulties associated with the prior art.

### SUMMARY OF THE INVENTION

The invention relates to a balance shoe including a locking mechanism for engaging a rigid sash guide or window jamb when the sash is tilted out of, or removed from, the frame. When the sash is returned to its normal vertical position, the balance shoe locking mechanism disengages from the window jamb, allowing the sash to travel vertically in the window jamb, subject to the force applied by the balance and a user.

In one aspect, the invention relates to a balance shoe for use in a window jamb. The balance shoe includes a slide block positionable in the window jamb, a pivoting locking member coupled to the slide block and biased into a locking position, and a camming surface disposed on the pivoting locking member. Upon application of a force, the camming surface retracts the pivoting locking member from the locked position. The slide block may also include oppositely disposed sliding surfaces for guiding the slide block in the window jamb.

In various embodiments, the pivoting locking member includes teeth for engaging the window jamb. The teeth are extendable beyond the slide block to penetrate the window jamb a limited depth. In yet another embodiment, the pivoting locking member is biased into a locked position by a spring. In one embodiment, the camming surface is engagable with a pivot bar disposed on a window sash. In another embodiment, the balance shoe is adapted to attach to at least one of a window balance and a balance cord. The balance shoe may be made from any suitable material such as metal, polymer, wood, and combinations thereof.

In another aspect, the invention relates to a window balance system for use in a window jamb. The system includes a window balance and a balance shoe coupled to the window balance. The balance shoe includes a slide block positionable in the window jamb, a pivoting locking member coupled to the slide block and biased into a locking position when installed in the jamb, and a camming surface disposed on the pivoting locking member. Upon application of a force, the camming surface retracts the pivoting locking member from the locked position. The slide block may also include oppositely disposed sliding surfaces for guiding the slide block in the window jamb.

In various embodiments, the pivoting locking member includes teeth for engaging the window jamb. The teeth are extendable beyond the slide block to penetrate the window jamb a limited depth. In yet another embodiment, the pivoting locking member is biased into a locked position by a spring. In one embodiment, the camming surface is engagable with a pivot bar disposed on a window sash.

In another aspect, the invention relates to a tilt-in window sash assembly. The assembly includes a frame that includes a window jamb. Also included in the assembly is at least one tilt-in window sash. The tilt-in window sash is operatively slideable in the window jamb and can be tilted with respect to the window jamb. The assembly also includes at least one window balance coupled to a balance shoe and the window jamb, the balance shoe positionable in the window jamb. The balance shoe includes a slide block positionable in the window jamb, a pivoting locking member coupled to the slide block and biased into a locking position when installed in the jamb, and a camming surface disposed on the pivoting locking member. Upon application of a force, the camming surface retracts the pivoting locking member from the locked position. The slide block may also include oppositely disposed sliding surfaces for guiding the slide block in the window jamb.

In various embodiments, the pivoting locking member includes teeth for engaging the window jamb. The teeth are extendable beyond the slide block to penetrate the window jamb a limited depth. In yet another embodiment, the pivoting locking member is biased into a locked position by a spring. In one embodiment, the camming surface is engagable with a pivot bar disposed on the window sash.

In another aspect, the invention provides a method for locking and unlocking a balance shoe in a window frame. The method includes the step of providing a balance shoe disposed in a jamb of a window, the balance shoe including a locking member biased in a locking position. Also included is the step of retracting the locking member with a component coupled to a sash slideable in the jamb.

In one embodiment, the step of retracting the locking member includes engaging a pivot bar coupled to the sash with a camming surface on the locking member. In another embodiment, the balance shoe in the locked position includes a member extendable beyond the slide block to penetrate the jamb a limited depth. In another embodiment, the locking member is biased into a locked position by a spring. The balance shoe can also be adapted to attach to at least one of a window balance and a window balance cord. In another embodiment, the balance shoe includes oppositely disposed sliding surfaces for guiding the balance shoe in the jamb.

These and other objects, along with the features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis generally being placed upon illustrating the principles of the invention. In the following description, various embodiments of the present invention are described with reference to the following drawings, in which:

FIG. 1 is a schematic perspective view of a window including a tilt-in sash;

FIG. 2 is an enlarged schematic perspective view of a portion of the tilt-in window of FIG. 1;

FIG. 3 is a schematic front view of one embodiment of a balance shoe in accordance with the invention shown in a locked position;

FIG. 4 is a schematic side view of the balance shoe of FIG. 3;

FIG. 5 is a schematic front view of the balance shoe of FIG. 3 shown in an unlocked position; and

FIG. 6 is a schematic side view of the balance shoe of FIG. 5.

### DESCRIPTION

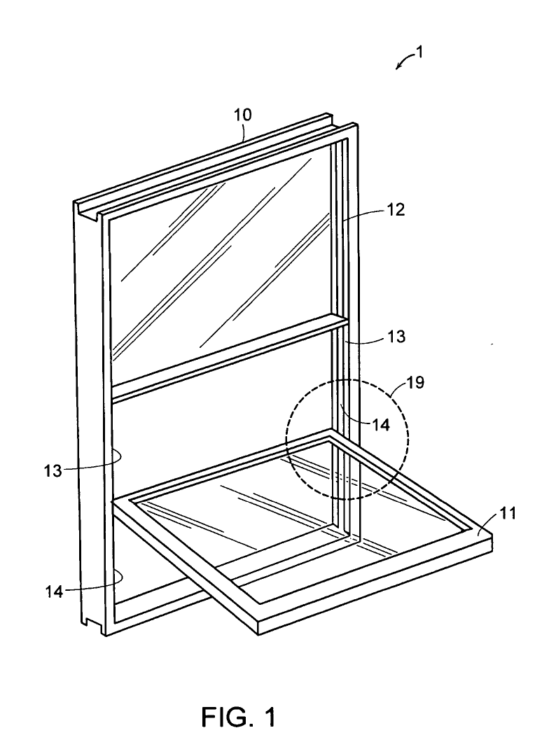

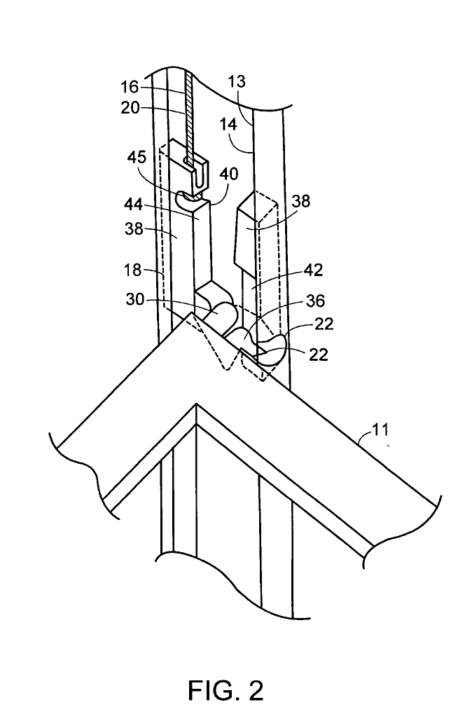

FIG. 1 depicts a tilt-in window sash assembly 1, in which a balance shoe constructed in accordance with the teachings of the present invention can be used. The pivotable double hung window assembly 1 includes a frame 10, a pivotable lower window sash 11, a pivotable upper window sash 12, and a pair of window jambs 13. The pivotable lower window sash 11 and the pivotable upper window sash 12 slide vertically in jamb tracks 14 formed in the window jambs 13, while each is also pivotable about a pair of pivot bars 30 (FIG. 2).

Typically, each sash 11, 12 is coupled to a pair of window balances 16 on each side of the sash 11, 12 with the window balances 16 (FIG. 2) being disposed in the window jambs 13. The window balances 16 provide a biasing force that offsets the weight of the sashes 11, 12, thereby making it easier for a user to move the sashes 11, 12 vertically in the jamb tracks 14. The window balances 16 can be any type of suitable balance, such as block and tackle balances, like those disclosed in U.S. Pat. No. 5,737,877, the disclosure of which is hereby incorporated by reference herein in its entirety. It is important to note, however, that the balance shoe 18 of the present invention can be used with any of a variety of balances and is not limited to use with block and tackle type balances.

When the sash 11 is in a tilted position, as depicted in FIG. 1, or is removed from the frame 10, it is desirable to lock the balance shoes 18 in a fixed vertical position. Therefore, balance shoes 18 that include a locking mechanism are provided to lock the balance shoes 18 within the jamb tracks 14 of the window jambs 13. As illustrated in the enlarged view, shown in FIG. 2, the balance shoe 18 is slideably mounted in the jamb track 14 and is coupled to a cord 20 of the window balance 16. Also coupled to the balance shoe 18 is the sash 11, as will be further described below.

FIGS. 2-6 depict one embodiment of the present invention, with the balance shoe 18 in various states. In the locked position, as occurs when the sash 11, 12 is tilted into a room as shown in FIGS. 1 and 2, or removed from the frame 10, the balance shoe 18 locks itself in a fixed position within the window jamb 13 by embedding a pair of pointed teeth 22 into walls of the jamb track 14 or, alternatively, the window jamb 13. The window balance 16 is, therefore, maintained in a fixed vertical position within the window jamb 13 and the sashes 11, 12 may be readily replaced or cleaned, without the window balance 16 releasing, which can potentially cause damage to the window jamb 13 or to the sashes 11, 12. When the sash 11 shown in FIG. 1 is rotated into its normal vertical position in the frame 10, the teeth 22 of the balance shoe 18 are retracted and disengaged from the walls of the jamb 13 or track 14, which enables the sash 111 to travel vertically.

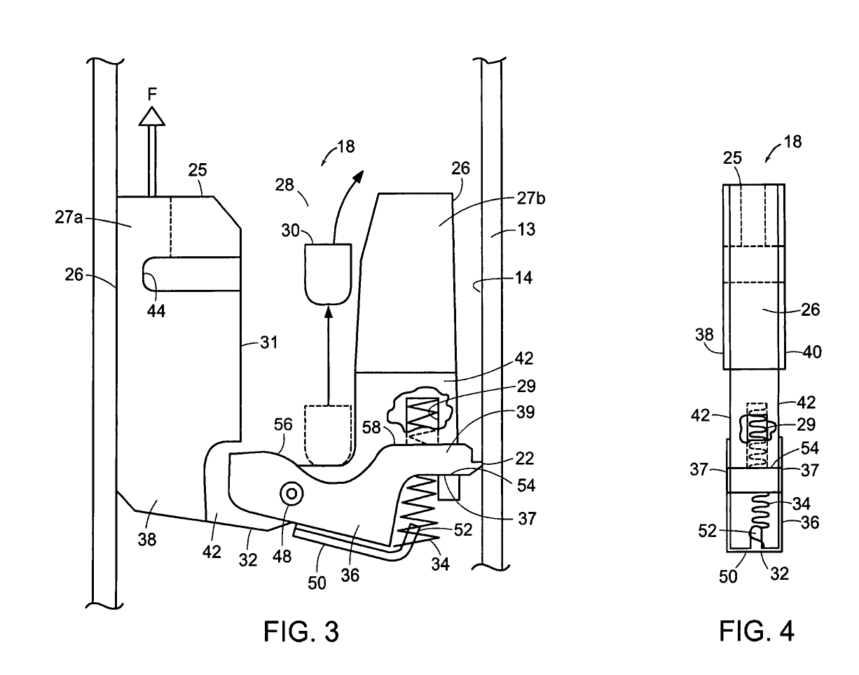

Referring to FIGS. 3 and 4, the balance shoe 18 is shown in the locked position in the jamb track 14. The balance shoe 18 includes a generally “U” shaped slide block 25. Generally, it is desirable for the slide block 25 of the balance shoe 18 to be made from materials with a low coefficient of friction, such that the balance shoe 18 can slide with minimal resistance in the jamb track 14 of the window jamb 13. Moreover, it is desirable for the slide block 25 to be resistant to wear and made from a material or combinations of materials that can be easily manufactured and machined. For these reasons, the slide block 25 can be made from a molded plastic material, which can then be machine finished or smoothed to reduce friction on the opposed sliding side surfaces 26. In one embodiment, the slide block 25 is made from acetal, for example Celcon® (Celcon® is a registered trademark of Celanese Chemical Co., New York, N.Y.) or Delrin® (Delrin® is a registered trademark of Hercules, Inc. Wilmington, Del.). In another embodiment, the slide block 25 can be made from any other suitable material, such as metals, polymers, woods, and various combinations thereof.

The “U” shaped slide block 25 has a closed lower end 32, legs 27a, 27b that extend upwardly from the closed lower end 32, and an open upper end 28 for receiving the pivot bar 30. Oppositely disposed sliding side surfaces 26 are disposed on legs 27a, 27b. Although the illustrated embodiment is depicted having legs 27a, 27b that are approximately equal in height, thereby forming the “U” shaped channel 31, in other embodiments the legs 27a, 27b may have different heights. For example, leg 27a may be approximately half the height of leg 27b, which will reduce the depth of the “U” shaped channel 31. In general, the legs 27a, 27b may be any height desired so long as surfaces remain to guide the pivot bar 30 into engagement with the pivoting locking member 36 (further described below).

Coupled to the slide block 25 is a biasing member 34, such as a compression spring, that biases a toothed pivoting locking member 36 into engagement with the jamb 13 or track 14. In the illustrated embodiment, the compression spring 34 is coupled to the slide block 25 by being fit into a bore 29 that extends vertically into the slide block 25 proximate the closed lower end 32. It will be appreciated, however, that the compression spring or other biasing member 34 may be attached to the slide block 25 using any means known in the art. Moreover, it will also be appreciated that the biasing member 34 is not limited to a compression spring, but could include any conventional element capable of applying the desired biasing force, such as a torsion spring or a cantilevered element. Alternatively, the locking member 36 could be weighted and supported, such that the teeth 22 automatically move into an engaged position, whenever they are not positively retracted or restrained.

Further formed on the slide block 25 on its front surface 38 and back surface 40 (FIG. 4) are optional recessed surfaces 42 for receiving the pivoting locking member 36. When the pivoting locking member 36 is coupled to the slide block 25, the recessed surfaces 42 prevent the side walls 39 of the pivoting locking member 36 from protruding beyond the front surface 38 and back surface 40 of the slide block 25 and potentially binding in the jamb 14. The slide block 25 also forms an opening 44 for attaching the slide block 25 directly or indirectly to either the window balance 16 or the balance cord 20 of such an assembly, as shown in FIG. 2. In one embodiment, a coupling 45 (FIG. 2) attached at one end to the window balance 16 or cord 20 of the window balance can be snap-fit into the opening 44.

With continuing reference to FIG. 3, the pivoting locking member 36 is coupled to the slide block 25 at the block's lower end 32 by a pivot pin 48. The pivoting locking member 36 is preferably made of a metal, such as aluminum, or any other material sufficient to withstand the loads the pivoting locking member 36 encounters in use. The pin 48 can be a rivet that extends through a bore from the front surface 38 to the back surface 40 of the slide block 25. The pin 48 enables the pivoting locking member 36 to rotate clockwise and counter-clockwise about the pin 48 in relation to the slide block 25. It will be appreciated that the pin 48 could also be a bearing or any other device that enables the pivoting locking member 36 to rotate freely relative to the slide block 25.

Disposed on the pivoting locking member 36 is a base 50 that further includes a finger 52. It will be appreciated that the base 50 can either be integral with the pivoting locking member 36 or can be a separate piece that is coupled to the pivoting locking member 36. Coupled to the finger 52 is the biasing member 34, the other end of which is coupled to the slide block 25. It will be appreciated that the biasing member 34 can be coupled to the pivoting locking member 36 using other techniques, such as having the biasing member 34 snuggly fit into a bore disposed on the pivoting locking member 36. It is to be understood that the scope of this application is not limited by the technique used to couple the biasing member 34 to the pivoting locking member 36.

Also disposed on the pivoting locking member are the teeth 22 that are sharp and capable of penetrating the walls of the jamb track 14 or the jamb channel 13. The teeth 22 are shown as being integral with the pivoting locking member 36, but can also be separate pieces that are coupled to the pivoting locking member 36.

With continuing reference to FIG. 3, further included on the pivoting locking member 36 along its top portion 58 is a camming surface 56. When a sash 11, 12 is tilted into a room and then removed from the frame 10, the pivot bar 30 of the sash 11 disengages from the camming surface 56 and travels initially to the right (as depicted in FIG. 3) and then vertically in the “U” shaped channel 31. The legs 27a, 27b may help guide the pivot bar 30 vertically as the pivot bar 30 is removed from engagement with the slide block 25. Disengaging the pivot bar 30 from the camming surface 56 results in the pivoting locking member 36 being biased into the locked position by the biasing member 34. Specifically, when the pivot bar 30 is disengaged from the camming surface 56, the downward force supplied by the biasing member 34 on the finger 52 tends to rotate the pivoting locking member 36 clockwise about the pin 48 as depicted in FIG. 3. This causes a lower surface 37 of the pivoting locking member 36 to abut a ledge 54 on the slide block 25. When the lower surface 37 of the pivoting locking member 36 abuts the ledge 54, the teeth 22 of the pivoting locking member 36 are generally perpendicular to the wall of the jamb track 14 and window jamb 13 and are embedded in the wall of the jamb track 14 or jamb channel 13. In this position, when the teeth 22 of the pivoting locking member 36 are embedded in the wall of the jamb track 14, the balance shoe 18 is prevented from sliding vertically along the jamb track 14 under the applied force (F) of the balance.

It will be appreciated that the teeth 22 will remain biased in the locked position, because of the biasing member 34, and also because of the interaction of the ledge 54 and the window balance 16. For instance, when the pivot bar 30 is rotated or lifted out of the open end 28 of the balance shoe 18, such as when the sash 11 is tilted or lifted out of the window frame 10, the window balance applies an upward force (F) on the balance shoe 18. The upward force (F) on the balance shoe 18, in cooperation with the clockwise movement of the pivoting locking member 36 about the pivot pin 48 caused by the spring 34, drives the teeth 22 in the jamb tack 14 and wedges the shoe 18 in the jamb 13. The ledge 54 disposed on the balance shoe 18 prevents the pivoting locking member 36 from rotating too far clockwise, such that the teeth 22 are disengaged from the jamb track 14. Therefore, when the sashes 11, 12 are tilted out of, or are removed from the frame 10, the balance shoe 18 remains locked in a fixed vertical position.

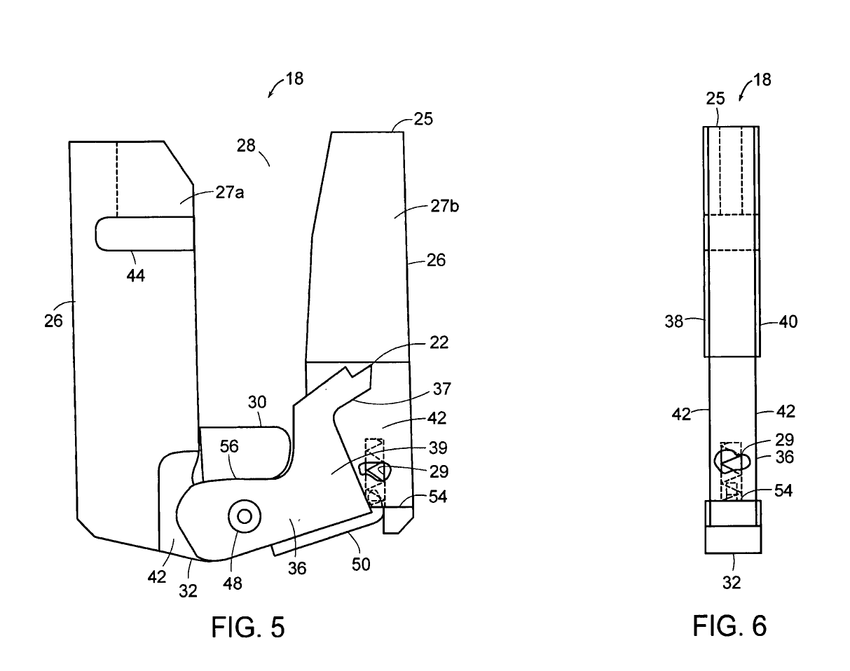

Conversely, referring to FIGS. 5 and 6, when the sash 11 is disposed vertically in the frame 10, the pivot bar 30 abuts the camming surface 56 and the weight of the sash 11 provides a counter-clockwise moment about the pin 48 that is greater than the clockwise moment provided by the biasing member 34. Consequently, the pivoting locking member 36 rotates counter-clockwise about the pin 48, thereby disengaging the teeth 22 of the pivoting locking member 36 from the jamb track 14. When the teeth 22 are disengaged from the jamb track 14, the sash 11 is free to move vertically along the jamb track 14.

Another advantage of the present invention is that when installing a sash 11, 12 into the balance shoe 18, the angle of the sash 11, 12 can be at any convenient angle relative to the frame 10. For instance, the sash 11, 12 does not need to be perpendicular to the frame 10 to lock the balance shoes 18. Moreover, it is not necessary for the balance shoes 18 in the window to be accurately horizontally aligned with each other for the balance shoes 18 to function correctly. For instance, when installing a sash 11, 12, the pivot bar 30 mating with one window balance 16 can be attached to its respective balance shoe 18 and then the pivot bar 30 mating with the second window balance 16 can be attached to its balance shoe 18 at another elevation.

Other embodiments incorporating the concepts disclosed herein may be used without departing from the spirit and scope of the invention. The described embodiments are to be considered in all respects as only illustrative and not restrictive.

1. A balance shoe for use in a window jamb, comprising:
a slide block;
a pivoting locking member coupled to the slide block and biased into a locking position when installed in the jamb, the pivoting locking member comprising a portion extending beyond a lower end of the slide block at least when the pivoting locking member is in the locking position; and
a camming surface disposed on the pivoting locking member that, upon application of a force, retracts the pivoting locking member from the locked position.

2. The balance shoe of claim 1, wherein the slide block comprises oppositely disposed sliding surfaces for guiding the slide block in the window jamb.

3. The balance shoe of claim 1, wherein the pivoting locking member comprises teeth for engaging the window jamb.

4. The balance shoe of claim 3, wherein the teeth are extendable beyond the slide block to penetrate the window jamb.

5. The balance shoe of claim 1, wherein the pivoting locking member is biased into a locked position by a spring.

6. The balance shoe of claim 1, wherein the camming surface is engagable with a pivot bar disposed on a window sash.

7. The balance shoe of claim 1, wherein the balance shoe is adapted to attach to at least one of a window balance and a window balance cord.

8. The balance shoe of claim 1, wherein the balance shoe is made from a material selected from the group consisting of metal, polymer, wood, and combinations thereof.

9. A window balance system for use in a window jamb, comprising:
a window balance;
a balance shoe coupled to the window balance, the balance shoe comprising:
a slide block;
a pivoting locking member coupled to the slide block and biased into a locking position when installed in the jamb, the pivoting locking member comprising a portion extending beyond a lower end of the slide block at least when the pivoting locking member is in the locking position; and
a camming surface disposed on the pivoting locking member that, upon application of a force, retracts the pivoting locking member from the locked position.

10. The balance shoe of claim 9, wherein the pivoting locking member comprises teeth for engaging the window jamb.

11. The balance shoe of claim 10, wherein the teeth are extendable beyond the slide block to penetrate the window jamb.

12. The balance shoe of claim 9, wherein the pivoting locking member is biased into a locked position by a spring.

13. The balance shoe of claim 9, wherein the slide block comprises oppositely disposed sliding surfaces for guiding the slide block in the window jamb.

14. The balance shoe of claim 9, wherein the camming surface is engagable with a pivot bar disposed on a window sash.

15. A tilt-in window sash assembly, comprising:
a frame comprising a window jamb;
at least one tilt-in window sash, the tilt-in window sash operatively slideable in the window jamb and tiltable with respect thereto; and
at least one window balance coupled to a balance shoe and the window jamb, the balance shoe positionable in the window jamb and comprising:
a slide block;
a pivoting locking member coupled to the slide block and biased into a locking position when installed in the jamb, the pivoting locking member comprising a portion extending beyond a lower end of the slide block at least when the pivoting locking member is in the locking position: and
a camming surface disposed on the pivoting locking member that, upon application of a force, retracts the pivoting locking member from the locked position.

16. The balance shoe of claim 15, wherein the pivoting locking member comprises teeth for engaging the window jamb.

17. The balance shoe of claim 16, wherein the teeth are extendable beyond the slide block to penetrate the window jamb.

18. The balance shoe of claim 15, wherein the pivoting locking member is biased into a locked position by a spring.

19. The balance shoe of claim 15, wherein the camming surface is engagable with a pivot bar disposed on the window sash.

20. The balance shoe of claim 15, wherein the slide block comprises oppositely disposed sliding surfaces for guiding the slide block in the window jamb.

21. A method for locking and unlocking a balance shoe in a window frame, comprising the steps of:
providing a balance shoe comprising a locking member biased in a locking position, the locking member comprising a portion extending beyond a lower end of the balance shoe at least when the locking member is in the locking position, the balance shoe disposed in a jamb of the window; and
retracting the locking member with a component coupled to a sash slideable in the jamb.

22. The method of claim 21, wherein the step of retracting the locking member comprises engaging a pivot bar coupled to the sash with a camming surface on the locking member.

23. The method of claim 21, wherein the balance shoe in the locked position comprises a member extendable beyond the slide block to penetrate the jamb a limited depth.

24. The method of claim 21, wherein the locking member is biased into a locked position by a spring.

25. The method of claim 21, wherein the balance shoe is adapted to attach to at least one of a window balance and a window balance cord.

26. The method of claim 21, wherein the balance shoe comprises oppositely disposed sliding surfaces for guiding the balance shoe in the jamb.
